(19) United States
(12) Patent Application Publication
(10) Pub. No.: US 2026/0105729 A1
(43) Pub. Date: Apr. 16, 2026

(54) SYSTEMS AND METHODS FOR ACCELERATED VIDEO-BASED TRAINING OF MACHINE LEARNING MODELS

(71) Applicant: Tesla, Inc., Austin, TX (US)

(72) Inventors: Tim ZAMAN, Austin, TX (US); Yinglin SUN, Austin, TX (US); Jeffrey BOWLES, Austin, TX (US); Ivan GOZALI, Austin, TX (US)

(73) Assignee: Tesla, Inc., Austin, TX (US)

(21) Appl. No.: 19/115,191

(22) PCT Filed: Sep. 29, 2023
(86) PCT No.: PCT/US2023/034168

§ 371 Date: Mar. 25, 2025

Related U.S. Application Data
(60) Provisional application No. 63/377,954, filed on Sep. 30, 2022.
(60) Provisional application No. 63/378,012, filed on Sep. 30, 2022.

(51) Int. Cl. G06V 10/774; G06V 20/40; G06V 20/56; H04N 19/172; H04N 19/436; H04N 19/70

(52) U.S. Cl. CPC G06V 10/774; G06V 20/49; H04N 19/172; H04N 19/436; H04N 19/70; G06V 20/56

(57) ABSTRACT

Systems and methods can include a computing system receiving a bitstream of a video sequence and one or more indications indicative of one or more image frames of the video sequence, determining, by parsing the bitstream, timestamps, positions within the bitstream and types of image frames of the video sequence and determining, using the one or more indications and the timestamps, positions within the bitstream and types of the image frames of the video sequence, one or more segments of the bitstream for decoding to extract the one or more image frames. For an image frame of the one or more image frames, a corresponding segment represents a corresponding referencing chain of image frames of the video sequence. The computing system can decode the one or more segments of the bitstream and use the one or more image frames to train the ML model.

### CROSS-REFERENCE TO RELATED PATENT APPLICATIONS

The present application claims priority to U.S. Provisional Application No. 63/377,954, filed Sep. 30, 2022, and U.S. Provisional Application No. 63/378,012, filed Sep. 30, 2022, each of which is incorporated herein by reference in its entirety for all purposes.

### TECHNICAL FIELD

The present disclosure generally relates to video training of machine learning (IL) models. In particular, the current disclosure relates to systems and methods for accelerated training of ML models with video data.

### BACKGROUND

Autonomous navigation technology used for autonomous vehicles and robots (collectively, egos) has become ubiquitous due to rapid advancements in computer technology. These advances allow for safer and more reliable autonomous navigation of egos. Egos often need to navigate through complex and dynamic environments and terrains that may include vehicles, traffic, pedestrians, cyclists, and various other static or dynamic obstacles. Understanding the egos' surroundings is necessary for informed and competent decision-making to avoid collisions.

### SUMMARY

Systems, devices, and methods described herein provide accelerated training of machine learning (ML) models. In particular, for ML models trained with video data, the systems, devices, and methods described herein enable fast decoding of video data and efficient use of computational and memory resources. For ML models or artificial intelligence (AI) models used to predict or sense the surroundings of egos, such as occupancy networks, the training of such models is extremely time consuming. The systems, devices and methods described herein significantly accelerate the training and/or validation of such models.

In one embodiment, a method can comprise receiving, by a processor, a bitstream of a video sequence and one or more indications indicative of one or more image frames of the video sequence for training a machine learning (ML) model; determining, by the processor, by parsing the bitstream, timestamps, positions within the bitstream and types of image frames of the video sequence; determining, by the processor, using the one or more indications and the timestamps, positions within the bitstream and types of the image frames of the video sequence, one or more segments of the bitstream for decoding to extract the one or more image frames, such that for an image frame of the one or more image frames, a corresponding segment represents a corresponding referencing chain of image frames of the video sequence; decoding, by the processor, the one or more segments of the bitstream; and using, by the processor, the one or more image frames to train the ML model.

The method can further comprise allocating, by the processor, a memory region within a memory of the processor; storing, by the processor, the bitstream in the allocated memory region; and storing, by the processor, the one or more image frames, after decoding the one or more segments, in the allocated memory region.

For each image frame of the one or more image frames, the corresponding referencing chain of image frames may start at an intra-frame (I-frame) of the video sequence and ends at the image frame of the one or more image frames.

Determining the timestamps, positions in the bitstream, and types of the image frames of the video sequence can include generating one or more data structures, the one or more data structures storing (i) for each image frame of the video sequence, a corresponding timestamp and a corresponding offset indicative of a corresponding position of compressed data of the image frame in the bitstream, and (ii) for each image frame of image frames of a specific type in the video sequence, a corresponding indication of the specific type.

The processor can be a graphical processing unit (GPU). In some implementations, the one or more segments of the bitstream can be decoded by a hardware decoder integrated in the processor.

The one or more indications can include one or more time values and determining the one or more segments of the bitstream includes, for each time value of the one or more time values, can include determining a first timestamp that is closest to the time value among the timestamps of the image frames of the video sequence, such that the first timestamp corresponds to a first image frame in the video sequence; determining a second timestamp of an I-frame of the video sequence, the second timestamp determined as a closest I-frame timestamp to the first timestamp that is smaller than or equal to the first timestamp; determining, using the second timestamp, a starting position of the I-frame in the bitstream among the positions of the image frames; determining, using the first timestamp, an ending position of the first image frame in the bitstream among the positions of the image frames; and determining a segment of the bitstream to extend between the starting position of the I-frame and the ending position of the first image frame.

The bitstream can be a first bitstream of a first compressed video sequence captured by a first camera and the method can further comprise receiving, by the processor, a second bitstream of a second video sequence captured by a second camera; determining, by the processor, by parsing the second bitstream, timestamps, positions within the second bitstream and types of image frames of the second video sequence; determining, by the processor, using the one or more indications and the timestamps, positions within the second bitstream and types of the image frames of the second video sequence, one or more segments of the second bitstream for decoding to extract one or more second image frames of the second video sequence, such that for an image frame of the one or more second image frames, a corresponding segment of the second bitstream represents a corresponding referencing chain of image frames of the second video sequence; decoding, by the processor, the one or more segments of the second bitstream; and using, by the processor, the one or more second image frames to train the ML, model. The first camera and the second camera may not be synchronized with each other.

At least two segments of the one or more segments of the first bitstream and the one or more segments of the second bitstream can be decoded in parallel by at least two hardware decoders integrated in the processor.

In another embodiment, a computing device can comprise a memory and a processing circuitry. The processing circuitry can be configured to receive a bitstream of a video sequence and one or more indications indicative of one or more image frames of the video sequence for training a machine learning (ML) model; determine, by parsing the bitstream, timestamps, positions within the bitstream and types of image frames of the video sequence; determine, using the one or more indications and the timestamps, positions within the bitstream and types of the image frames of the video sequence, one or more segments of the bitstream for decoding to extract the one or more image frames, such that for an image frame of the one or more image frames, a corresponding segment represents a corresponding referencing chain of image frames of the video sequence; decode the one or more segments of the bitstream; and use the one or more image frames to train the ML model.

The processing circuitry can be further configured to allocate a memory region within the memory; store the bitstream in the allocated memory region; and store the one or more image frames, after decoding the one or more segments, in the allocated memory region.

For each image frame of the one or more image frames, the corresponding referencing chain of image frames can start at an intra-frame (I-frame) of the video sequence and ends at the image frame of the one or more image frames.

In determining the timestamps, positions in the bitstream, and types of the image frames of the video sequence, the processing circuitry can be configured to generate one or more data structures. The one or more data structures can store (i) for each image frame of the video sequence, a corresponding timestamp and a corresponding offset indicative of a corresponding position of compressed data of the image frame in the bitstream, and (ii) for each image frame of image frames of a specific type in the video sequence, a corresponding indication of the specific type.

The computing device can be a graphical processing unit (GPU). The one or more segments of the bitstream can be decoded by a hardware decoder integrated in the GPU.

The one or more indications can include one or more time values and in determining the one or more segments of the bitstream, the processing circuitry can be configured, for each time value of the one or more time values, to determine a first timestamp that is closest to the time value among the timestamps of the image frames of the video sequence, the first timestamp corresponding to a first image frame in the video sequence; determine a second timestamp of an I-frame of the video sequence, the second timestamp determined as a closest I-frame timestamp to the first timestamp that is smaller than or equal to the first timestamp; determine, using the second timestamp, a starting position of the I-frame in the bitstream among the positions of the image frames; determine, using the first timestamp, an ending position of the first image frame in the bitstream among the positions of the image frames; and determine a segment of the bitstream to extend between the starting position of the I-frame and the ending position of the first image frame.

The bitstream can be a first bitstream of a first compressed video sequence captured by a first camera and the processing circuitry can be further configured to receive a second bitstream of a second video sequence captured by a second camera; determine parsing the second bitstream, timestamps, positions within the second bitstream and types of image frames of the second video sequence; determine using the one or more indications and the timestamps, positions within the second bitstream and types of the image frames of the second video sequence, one or more segments of the second bitstream for decoding to extract one or more second image frames of the second video sequence, for an image frame of the one or more second image frames, a corresponding segment of the second bitstream represents a corresponding referencing chain of image frames of the second video sequence; decode the one or more segments of the second bitstream; and use the one or more second image frames to train the ML model. The first camera and the second camera may not be synchronized with each other.

At least two segments of the one or more segments of the first bitstream and the one or more segments of the second bitstream can be decoded in parallel by at least two hardware decoders integrated in the computing device.

In yet another embodiment, a non-transitory computer-readable medium can store computer code instructions thereon. The computer code instructions when executed by a processor can cause the processor to receive a bitstream of a video sequence and one or more indications indicative of one or more image frames of the video sequence for training a machine learning (ML) model; determine, by parsing the bitstream, timestamps, positions within the bitstream and types of image frames of the video sequence; determine, using the one or more indications and the timestamps, positions within the bitstream and types of the image frames of the video sequence, one or more segments of the bitstream for decoding to extract the one or more image frames, for an image frame of the one or more image frames, a corresponding segment represents a corresponding referencing chain of image frames of the video sequence; decode the one or more segments of the bitstream; and use the one or more image frames to train the ML model.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system, according to an embodiment.

FIG. 1B illustrates various sensors associated with an ego according to an embodiment.

FIG. 1C illustrates the components of a vehicle, according to an embodiment.

FIG. 2 illustrates a block diagram of a video training system, according to an embodiment.

FIG. 3 illustrates a flow chart diagram of a method for accelerated training of machine learning (ML) models with video data, according to an embodiment.

FIG. 4 illustrates a diagram depicting a set of selected image frames in a video sequence and the corresponding image frames to be decoded, according to an embodiment.

FIG. 5 illustrates a diagram of a bitstream corresponding to the video sequence of FIG. 4, the compressed data corresponding to the selected image frames and the compressed data corresponding to the frames to be decoded, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Training of ML models with video data is typically very time consuming. Also, processing (e.g., decoding) video sequences consumes significant processing power and memory. For ML models or AI models that are to be trained with a huge amount of video data, the training (or validation) of the models can be extremely time consuming and extremely demanding in terms of processing, memory, and bandwidth resources. For instance, training ML models or AI models to predict or sense the surroundings of egos involves using millions or even billions of video frames for training data. The video frames are typically stored as compressed video data. Decoding and processing such huge amount of video data to train the ML model(s) can take thousands and thousands of hours. The systems, devices and methods described herein provide accelerated training and more efficient use of computational and memory resources. In particular, the systems, devices and methods described herein enable accelerated training and/or validation of occupancy networks configured to predict or sense the three-dimensional surroundings of egos.

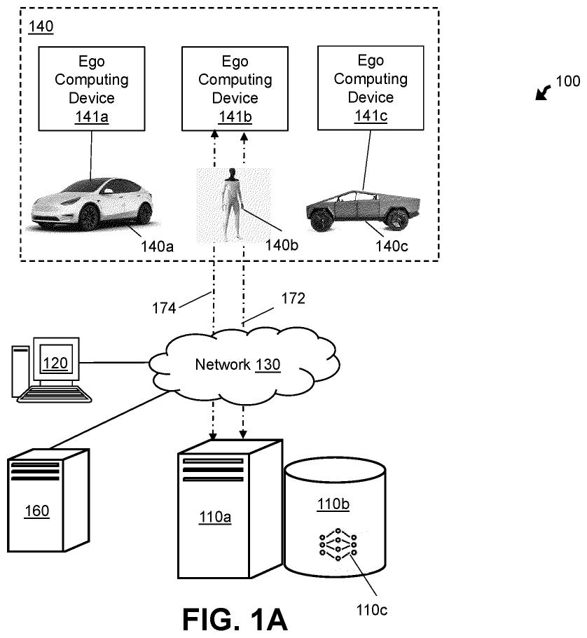

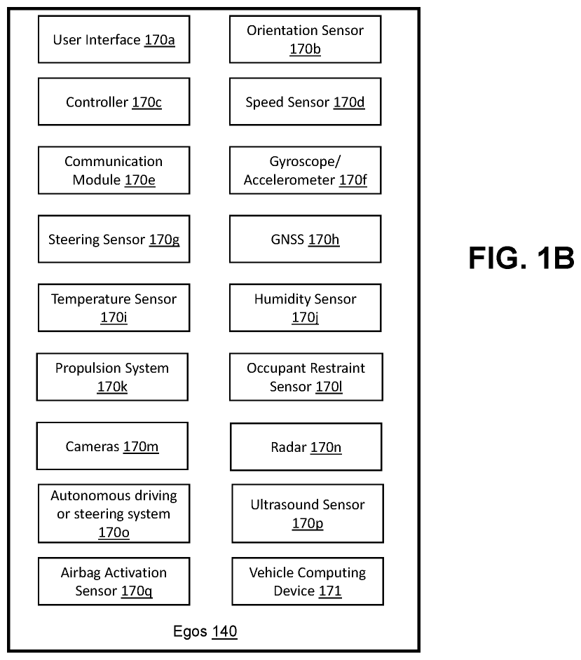

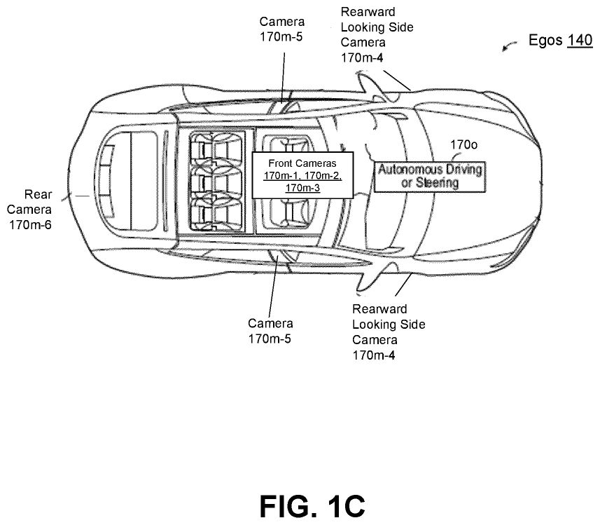

FIG. 1A is a non-limiting example of components of a system in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior- or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how to accelerate training of the AI model(s) 110c and/or other ML models with video data, the analytics server 110a can include a plurality of graphical processing units (GPUs) configured to train the AI model(s) 110c in parallel. For example, the analytics server 110a can include a supercomputer. Each GPU can receive video data (e.g., one or more bitstreams) and indications of video frames (or image frames) to be extracted from the video data and used to train the AI model(s) 110c. The GPU can decode only portions of the bitstream(s) needed to decode the selected image frames and use the selected image frames in decoded form to train the AI model(s) 110c.

In some implementations, each GPU can be configured or designed to perform a training step independently and without using external resources. In particular, the GPU can receive the video data, decode relevant portions or segments to extract selected image frames, extract features from the selected image frames and use the extracted features to train the AI model(s) 110c without using any external memory or processing resources. In other words, all the processing and data handling from the point of receiving the video data to the training of the AI model(s) 110c can be performed internally and independently within the GPU.

Each GPU can include one or more hardware video decoders integrated therein to speed up the video decoding. The GPU can include multiple video decoders to parallelize the video decoding. The parallelization can be implemented in various ways, e.g., per video segment, per bitstream, or per training session.

In some implementations, the GPU can have sufficient internal memory, e.g., cache memory, to store the data needed to execute a training step. The GPU can allocate a memory region within the memory to store data associated with a training step and use the allocated memory region for data storage throughout the training step.

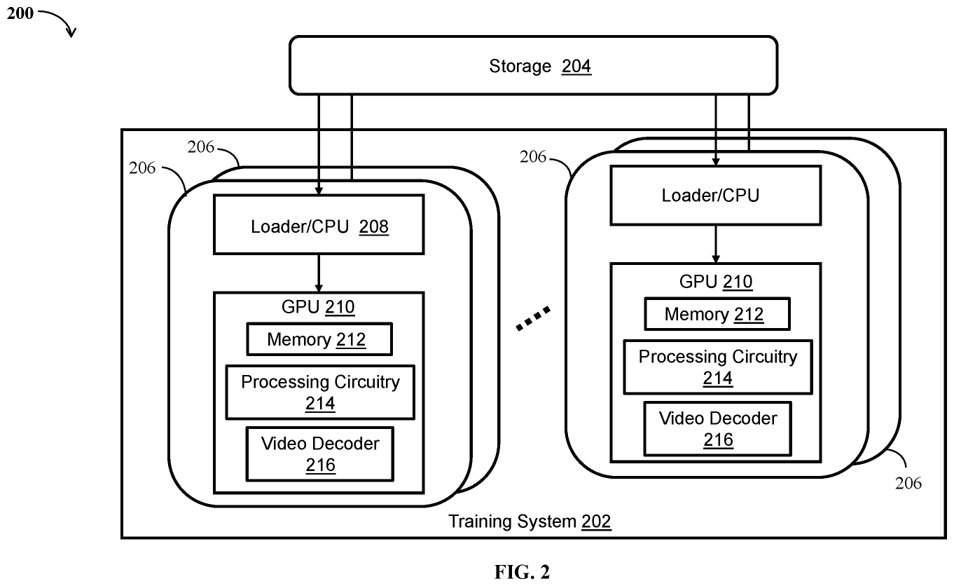

FIG. 2 illustrates a block diagram of computer environment 200 for training ML models, according to an embodiment. The computer environment 200 can include a training system 202 for training ML models and a data storage system 204 for storing training data and/or validation data. The training system 202 can include a plurality of training nodes (or processing nodes) 206. Each training node 206 can include a respective data loader (or data loading device) 208 and a respective graphical processing unit (GPU) 210. Each GPU 210 can include a memory, e.g., cache memory, 212, a processing circuitry 214 and one or more video decoders 216.

The data storage system 204 can include, or can be, a distributed storage system. For instance, the data storage system 204 can have an infrastructure that can split data across multiple physical servers, such super computers. The data storage system 204 can include one or more storage clusters of storage units, with a mechanism and infrastructure for parallel and accelerated access of data from multiple nodes or storage units of the storage cluster(s). For example, the data storage system 204 can include enough data links and bandwidth to deliver data to the training nodes 206 in parallel or simultaneously.

The data storage system 204 can include sufficient memory capacity to store millions or even billions of video frames, e.g., in compressed form. For example, the data storage system 204 can have a memory capacity to store multiple petabytes of data, e.g., 10, 20 or 30 petabytes. The data storage system 204 can allow for thousands of video sequences to be moving in and/or out of the data storage system 204 at any time instance. The relatively huge size and bandwidth of the storage system 204 allows for parallel training of one or more ML models as discussed below.

The training system 202 can be implemented as one or more physical servers, such as server 110a. For instance, the training system 202 can be implemented as one or more supercomputers. Each supercomputer can include thousands of processing or training nodes 206. The training nodes 206 can be configured or designed to support parallel training of one or more ML models, such as the AI model(s) 110c. Each training node 206 can be communicatively coupled to the storage system 204 to access data training data and/or validation data stored therein.

Each training node 206 can include a respective data loader 208 and a respective GPU 210 that are communicatively coupled to each other. The data loader 208 can be (or can include) a processor or a central processing unit (CPU) for handling data requests or data transfer between the corresponding GPU 210, e.g., the GPU 210 in the same training node 206, and the data storage system 204. For example, the GPU 210 can request one or more video sequences captured by one or more of the cameras 170m described in relation with FIG. 1C. For instance, the front or forward-looking cameras 170m-1, 170m-2 and 170m-3, the rearward looking side cameras 170m-4, the side cameras 170m-5 and the rear camera 170m-6 can simultaneously capture video sequences and send the video sequences to and stored in the data storage system 204 for storing. In some implementations, the data storage system 204 can store video sequences that are captured simultaneously by multiple cameras, such as cameras 170m, of the ego 140 as a bundle or a combination of video sequences that can be delivered together to a training node 206. For example, the data storage system 204 can maintain additional data indicative of which video sequences were captured simultaneously by the cameras 170m or represent the same scene from different camera angles. The data storage system 204 may maintain, e.g., for each stored video sequence, data indicative of an ego identifier, a camera identifier and a time instance associated with the video sequence.

The training nodes 206 can simultaneously train one or more ML models, e.g., in parallel, using video data captured by the cameras 170m of the ego 140 and stored in the data storage system 204. In some implementations, the video data can be captured by cameras 170m of multiple egos 140. In a training node 206, the corresponding data loader 208 can request video data of one or more video sequence(s) simultaneously captured during a time interval by one or more cameras 170m of an ego 140 from the data storage system 204 and send the received video data to the corresponding GPU 210 for use to execute a training step (or validation step) when training the ML model. The video data can be in compressed form. For instance, the video sequences can be encoded by encoders integrated or implemented in the ego 140. Each data loader 208 can have sufficient processing power and bandwidth to deliver video data to the corresponding GPU 210 in a way to keep the GPU 210 busy. In other words, the GPU 210 can be configured or designed, e.g., in terms of processing power and bandwidth, to request video data of a bundle of compressed video sequences from the data storage system 204 and deliver the video to the GPU 210 in a time duration less than or equal to the average time consumed by the GPU 210 to process a bundle of video sequences.

Each GPU 210 can include a corresponding internal memory 212, such as a cache memory, to store executable instructions for performing processes described herein, received video data of one or more video sequences, decoded video frames, features extracted from decoded video frames, parameters, or data of the trained ML model and/or other data used to train the ML model. The memory 212 can be large enough to store all the data needed to execute a single training step. As used herein, a training step can include receiving and decoding video data of a one or more video sequences (e.g., a bundle of video sequences captured simultaneously by one or more cameras 170m of an ego 140), extracting features from the decodes video data and using the extracted features to update parameters of the ML model being trained or validated.

Each GPU 210 can include a processing circuitry 214 to execute processes or methods described herein. The processing circuitry 214 can include one or more microprocessors, a multi-core processor, a digital signal processor (DSP), one or more logic circuits or a combination thereof. The processing circuitry 214 can execute computer code instructions, e.g., stored in the memory 212, to perform processes or methods described herein.

The GPU 210 can include one or more video decoder 216 for decoding video data received from the data storage system 204. The one or more video decoders 216 can include hardware video decoder(s) integrated in the GPU 110 to accelerate video decoding. The one or more video decoders 216 can be part of the processing circuitry 214 or can include separate electronic circuit(s) communicatively coupled to the processing circuitry 214.

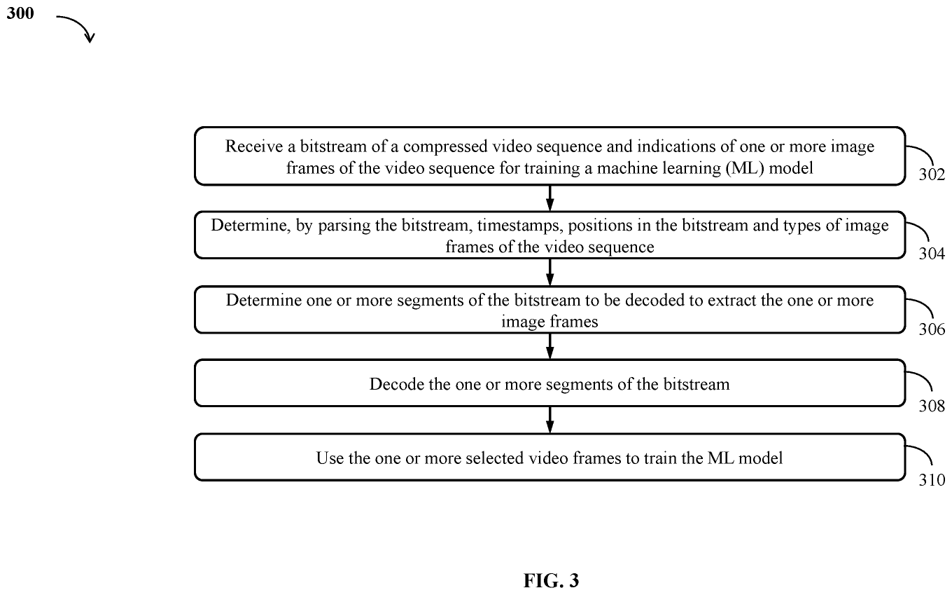

Each GPU 210 can be configured or designed to handle or execute a training step without using any external resources. The GPU 210 can include sufficient memory capacity and processing power to execute a training step. Processes performed by a training node 208 or a corresponding GPU 210 are described in further detail below in relation to FIGS. 3-6.

Referring now to FIG. 3, a flow chart diagram of a method 300 for accelerated training of machine learning (ML) models with video data, according to an embodiment. In brief overview, the method 300 can include receiving a bitstream of a video sequence and one or more indications indicative of one or more image frames of the video sequence for training a machine learning (ML) model (STEP 302) and determining, by parsing the bitstream, timestamps, positions within the bitstream and types of image frames of the video sequence (STEP 304). The method 300 can include determining, using the one or more indications and the timestamps, positions within the bitstream and types of the image frames of the video sequence, one or more segments of the bitstream for decoding to extract the one or more image frames (STEP 306). For an image frame of the one or more image frames, a corresponding segment can represent a corresponding referencing chain of image frames of the video sequence. The method 300 can include decoding the one or more segments of the bitstream (STEP 308) and using the one or more image frames to train the ML model (STEP 310).

The method 300 can be fully implemented, performed, or executed by GPU 210. The GPU 210 can perform the steps 302-310 without using any external memory or processing resources. Having the method 300 fully executed by a single GPU 210 leads to accelerated training of the ML model(s). In particular, by fully executing the method 300 within a single GPU 210, processing time can be reduced by avoiding exchange of data between the GPU 210 and any external resources. For instance, decoding video data or storing decoded video data outside the GPU 210 can introduce delays associated with the exchange of compressed and/or decoded video data between the GPU 210 and any external resources.

The method 300 can include the GPU 210 receiving the bitstream of the video sequence and one or more indications indicative of one or more image frames of the video sequence for training a machine learning (ML) model (STEP 302). In some implementations, the GPU 210 or the processing circuitry 214 can allocate a memory region within the memory 212 for a training step to be executed. For instance, prior to receiving the bitstream and the one or more indications, the processing circuitry 214 can allocate the memory region to store data for the next training step, such as compressed video data received from the storage system 204, decoded video or image frames, features extracted from the video frames and/or other data. In some implementations, the processing circuitry 214 can allocate the memory region at the start of each training step or can allocate the memory region at the beginning of a training session where the allocated memory region can be used for consecutive training steps. In some implementations, the processing circuitry 214 can overwrite segments of the allocated memory region (or of memory 212) that store data that is not needed anymore to make efficient use of the memory 212.

The GPU 210 can receive one or more bitstreams of one or more video sequences from the storage system 204 via the loader 208. For instance, the GPU 210 can receive multiple bitstreams of multiple compressed video sequences, e.g., that were simultaneously captured by the cameras 170m of the ego 140. The compressed video sequences can be encoded at the ego 140 and may not be synchronized. For instance, each camera 170m can have a separate timeline according to which image frames are captured and separate encoder for encoding captured image frames. The image capturing time instances for different cameras 170m may not be time-aligned. Also, the encoders associated with different cameras 170m may not be synchronized. As such image frames captured by different cameras 170m at the same time instance (or substantially at the same time instance considering any differences in timelines for capturing image frames by different cameras 170m) may have different timestamps when encoded by separate encoders in distinct bitstreams.

The GPU 210 can receive one or more indications indicative of image frames selected, or to be selected from the one or more video sequences for use to train the ML model. The one or more indicators can be specified by a user of the training system 202 and received by the GPU 210 as input, e.g., via the data loader 208. The one or more indications can include one or more time values. Each time value can be indicative of a separate image frame in each received bitstream. For example, if eight bitstreams of eight video sequences captured by eight different cameras 170m of ego 140 are received by the GPU 210, each time value would be indicative of eight image frames, e.g., an image frame in each video sequence. The time values can be indicative of, but not necessarily exactly equal to, the timestamps of the image frames selected or to be selected. The GPU 210 can store the received bitstream(s) and the one or more indications in the allocated memory region.

The method 300 can include the GPU 210 determining, by parsing the bitstream, timestamps, positions within the bitstream and types of image frames of the video sequence (STEP 304). Each video bitstream can include multiple headers distributed across the bitstream. The video bitstream can include a separate header for each compressed image frame in the bitstream. Each image frame header can immediately precede the compressed data of the image frame and can include data indicative of information about the image frame and the corresponding compressed data. The header can include a timestamp of the image frame, a type of the image frame, a size of the compressed image frame data, a position of the compressed image frame data in the bitstream and/or other data.

The type of the image frame can include an intra-frame (I-frame) type or a predicted-frame (P-frame). A P-frame is encoded using data from another previously encoded image frame. To decode a P-frame, a decoder would decode any other image frames upon which the P-frame depends before decoding the P-frame. An I-frame is also referred to as a reference frame and can be decoded independently of any other image frame. For an image frame, the corresponding timestamp represents the time of presentation of the image frame, e.g., relative to first image frame in the video sequence. The position of the compressed image frame data in the bitstream can be an offset value, e.g., in Bytes, indicative of where the compressed image frame data starts in the bitstream.

The processing circuitry 214 can parse each received bitstream to identify or determine the header of each compressed image frame in the bitstream. The processing circuitry 214 can read the headers in each bitstream to determine the timestamp, the position of the compressed image frame data, and the type of each image frame in each bitstream. The parsing the bitstream(s) is significantly lighter, in terms of processing power and processing time, compared to decoding a single bitstream or a portion thereof. The timestamps, positions within the bitstream and types of image frames determined by parsing the bitstream(s) enable significant reduction in the amount of video data to be decoded to extract the selected image frame(s), and therefore accelerate the training process significantly.

In determining the timestamps, positions in the bitstream and types of the image frames of the video sequence(s), the GPU 210 or the processing circuitry 214 can generate one or more data structures to store the timestamps, positions in the bitstream and types of the image frames of the video sequence(s). The one or more data structures can include a table, a data file and/or a data structure of some other type. For example, the processing circuitry 214 can generate a separate table, similar to Table 1 below, for each bitstream. The first leftmost column of Table 1 can include the timestamps of all the image frames in the video sequence, e.g., in increasing order, the second column can include the position (or offset) of the compressed frame data of each image frame and the rightmost column can include the type of each image frame. Each row of Table 1 corresponds to a separate image frame in the video sequence.

TABLE 1

| Timestamp | Position/Offset | Type |
|---|---|---|
| T₁ | O₁ | I |
| T₂ | O₂ | P |
| T₃ | O₃ | P |
| T₄ | O₄ | P |
| T₅ | O₅ | I |
| . | . | . |
| . | . | . |
| . | . | . |
| Tₙ | Oₙ | P |

In some implementations, the one or more data structures can include a first data structure for I-frames and a second data structure for all frames in the video sequence. Each of the first and second data structures can be a table or a data file. An example of the first data structure can be Table 2 below. Each row of Table 2 represents a separate I-frame in the video sequence. The first (e.g., leftmost) column can include the timestamps (e.g., in increasing order) of the I-frames and the second column can include the corresponding positions or offsets (e.g., in Bytes). The data in Table 2 allows for fast determination of the position of compressed data for any I-frame in the bitstream.

TABLE 2

| Timestamp | Position/Offset |
|---|---|
| T_{1, I} | O_{1, I} |
| T_{2, I} | O_{2, I} |
| T_{3, I} | O_{3, I} |
| . | . |
| . | . |
| . | . |
| T_{n, I} | O_{n, I} |

An example of the first data structure can be Table 3 below. Each row of Table 3 represents a separate image frame in the video sequence. The first (e.g., leftmost) column can include the timestamps of the image frames (e.g., in increasing order) and the second column can include the corresponding positions or offsets (e.g., in Bytes). The data in Table 3 allows for determination of the position of compressed data for any image frame in the bitstream.

TABLE 3

| Timestamp | Position/Offset |
|---|---|
| T₁ | O₁ |
| T₂ | O₂ |
| T₃ | O₃ |
| . | . |
| . | . |
| . | . |
| Tₙ | Oₙ |

The data of any of the tables above can be stored in a data file. Compared to Table 1, Table 2 and Table 3 may not include an indication of the image frame types. Instead, the I-frames can be identified from Table 2 which is specific to I-frames. In some implementations, other data structures (e.g., instead of or in combination with any of Table 1, Table 2 and/or Table 3) can be generated. Once generated, the GPU 210 or the processing circuitry 214 can store the one or more data structures in the memory 212. The one or more data structures can indicate (i) for each image frame of the video sequence, a corresponding timestamp and a corresponding offset indicative of a corresponding position of compressed data of the image frame in the bitstream, and (ii) image frames of a specific type in the video sequence.

The method 300 can include the GPU 210 determining, using the one or more indications and the timestamps, positions within the bitstream and types of the image frames of the video sequence, one or more segments of the bitstream for decoding to extract the one or more image frames (STEP 306). The one or more indications can include one or more time values for use to identify or determine selected image frames for use to train the ML model. Each time value can be indicative of one or more corresponding image frames or corresponding timestamp(s) in the received one or more received bitstreams. If multiple bitstreams corresponding to multiple cameras 170m are received, each indicator or time value can be indicative of a separate image frame or a corresponding timestamp in each of the received bitstreams.

For each time value of the one or more time values, the GPU 210 or the processing circuitry 214 can determine a corresponding timestamp that is closest to the time value for each received bitstream. For example, the processing circuitry 214 can use Table 3 (or Table 1) for a given bitstream to determine the closest timestamp of the bitstream to the time value. The processing circuitry 214 can determine a separate timestamp that is closest to the time value for each bitstream by using a corresponding data structure (e.g., Table 3 or Table 1). Each determined timestamp is indicative of a respective image frame in the corresponding bitstream that is indicated or selected via the time value. For example, if eight bitstreams corresponding to eight cameras 170m are received, the processing circuitry 214 can determine for each time value (or indicator) eight corresponding timestamps indicative of eight selected image frames with one selected image frame from each bitstream. If the GPU 210 receives three indicators and eight bitstreams corresponding to eight cameras 170m, the processing circuitry 214 can determine a total of 24 timestamps corresponds to 24 selected image frames where three timestamps corresponding to three selected image frames are determined for each bitstream.

The processing circuitry 214 can determine for each time value (or each indicator), a separate second timestamp for each received bitstream. For each bitstream, the second timestamp is indicative of a corresponding I-frame of the bitstream. For each time value, the processing circuitry 214 can determine the second timestamp for a given bitstream as the closest I-frame timestamp of the bitstream to the time value (or to the timestamp of the selected frame of the bitstream indicated by the time value) that is smaller than or equal to the time value (or smaller than or equal to the timestamp of the selected frame of the bitstream indicated by the time value). For instance, the processing circuitry 214 can use Table 2 (or Table 1) of a bitstream to determine the I-frame timestamp of the bitstream that is closest and smaller than or equal to a given time value (or indicator).

For a given time value (or indicator) and a given bitstream, if the timestamp of the selected image frame and the corresponding I-frame timestamp are equal, it means that the selected image frame (or image frame indicated by the time value) is an I-frame. However, if the two timestamps are different, the processing circuitry 214 can determine that the selected image frame (or image frame indicated by the time value) is not an I-frame.

The processing circuitry 214 can determine, for each time value (or indicator) and each received bitstream, a position or offset (e.g., starting position) of the I-frame in the bitstream using the I-frame timestamp and the one or more data structures. For example, the processing circuitry 214 can determine a position or an offset corresponding to the determined I-frame timestamp using Table 2 (or Table 1). For instance, if the determine I-frame timestamp is T_{3,1}, the corresponding offset is O_{3,1}.

The processing circuitry 214 can determine, for each time value (or indicator) and each received bitstream, using the timestamp of the corresponding selected image frame, an ending position of the corresponding selected image frame. The processing circuitry 214 can determine the ending position of the selected image frame in the bitstream as the starting position of the next (or following) image frame in the bitstream. The processing circuitry 214 can determine the ending position of the selected image frame in the bitstream as the starting position of the selected image frame plus the size of the compressed data of the bitstream. The processing circuitry 214 can determine the size of each image frame in a bitstream by parsing the bitstream or the frame headers and recording the sizes in the one or more data structures.

The processing circuitry 214 can determine, for each time value (or indicator) and each received bitstream, a corresponding segment of the bitstream extending between the starting position of the corresponding I-frame and the ending position of the corresponding selected image frame. The determined segment represents the minimum amount of compressed video data to be decoded in order to decode the selected image frame. If two or more segments corresponding to different time values (or different indicators), but from the same bitstream, overlap, the processing circuitry 214 can consider the longest segment for decoding and omit the shorter one(s).

It is to be noted that while the indicators are described above as time values, other implementations are possible. For example, the indicators received by the GPU 210 can be indices of images frames.

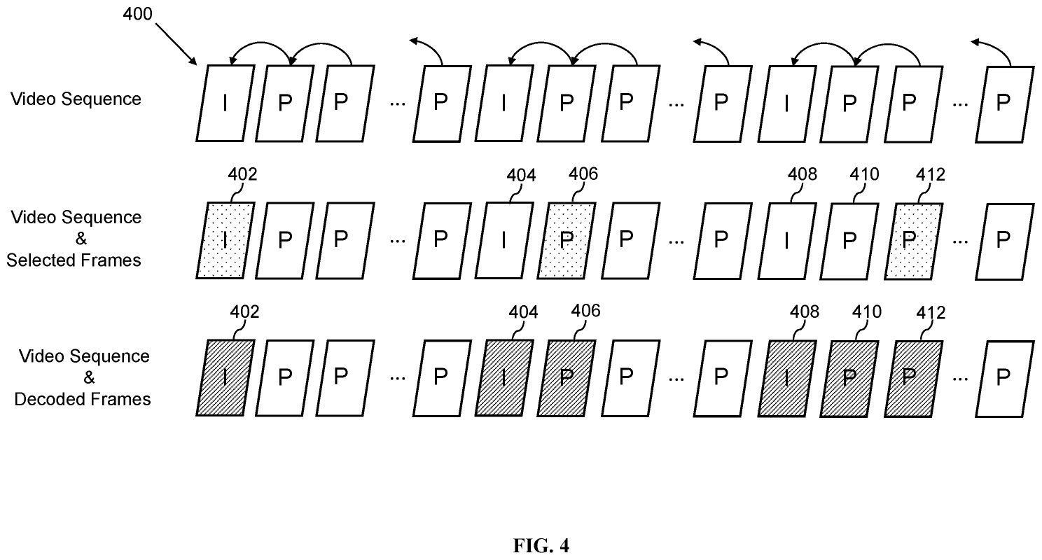

Referring now to FIG. 4, a diagram depicting a set of selected image frames in a video sequence 400 and the corresponding image frames to be decoded is shown, according to an embodiment. Using three different indicators or time values, the processing circuitry 214 can determine (e.g., as discussed above) the image frames 402, 406 and 412 as selected images frames or images frames indicated to be selected by the indicators or time values. The image frame 402 is an I-frame while the image frames 406 and 412 are P-frames. With regard to the selected image frame 402, the processing circuitry 214 determines that only the image frame 402 is to be decoded because it is an I-frame and does not depend on any other image frame. For the selected image frame 406, which is a P-frame, the processing circuitry 214 determines that closest preceding I-frame is image frame 404 and that both frames 404 and 406 are to be decoded in order to get the selected image frame 406 in decoded form. For the selected image frame 412, which is a P-frame, the processing circuitry 214 determines that closest preceding I-frame is image frame 408 and that frames 408, 410 and 412 are to be decoded in order to get the selected image frame 412 in decoded form.

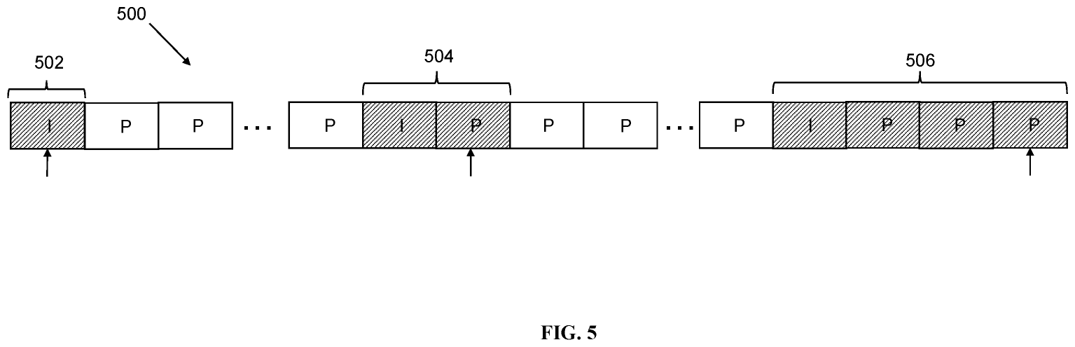

FIG. 5 illustrates a diagram of a bitstream 500 corresponding to the video sequence 400 of FIG. 4, the compressed data corresponding to the selected image frames and the compressed data corresponding to the frames to be decoded, according to an embodiment. The compressed data segment 502 represents the compressed data of the image frame 402. The compressed data segment 504 represents the compressed data of the image frames 404 and 406. The compressed data segment 506 represents the compressed data of the image frames 408, 410 and 412. Instead of decoding the whole bitstream 500, the processing circuitry 214 can feed only the compressed data segments 502, 504 and 506 to the video decoder(s) 216 for decoding.

For each selected image frame (or each image frame indicated for selection), the corresponding compressed data segment to be decoded can be viewed as representing a corresponding referencing chain of image frames. The referencing chain starts with the closest I-frame that precedes the selected frame and ends with the selected image frame. The referencing chain represents a chain of interdependent image frames with the dependency (frame referencing) starting at the selected image frame and going backward all the way to the first encountered I-frame. For example, in the referencing chain formed by the image frames 408, 410 and 412, the image frame 412 references image frame 410 and the latter references image frame 410, which is an I-frame.

Referring back to FIG. 3, the method 300 can include the GPU 210 decoding the one or more segments of the bitstream (STEP 308). The processing circuitry 214 can provide or feed the determined compressed data segments to the video decoder(s) 216 for decoding. By decoding only compressed data needed to decode the selected image frames, the GPU 210 significantly reduces the processing time and processing power consumed to decode the selected image frames (e.g., compared to decoding a whole bitstream). The processing circuitry 214 can store the decode video data in the memory 212. For efficient use of memory resources in the GPU 210, the video processing circuitry 214 can overwrite decoded video data that is not needed any more. For example, when decoding the compressed data segment 506, and once image frame 410 is decode, the processing circuitry 214 can determine that the data of decoded image frame 410 is not needed anymore and delete the decoded image frame 410 to free memory space. Once a compressed data segment corresponding to a selected image frame is decoded, only the decoded data for the selected image frame can be kept in the memory 212 or the allocated memory region while other decoded image frames (non-selected image frames) can be deleted to free memory space.

As discussed above, the GPU 210 can include multiple video decoders that can operate in parallel. The GPU 210 can perform parallel video decoding in various ways. For example, the processing circuitry 214 can assign different compressed data segments (regardless of the corresponding bitstreams) to different video decoders 216 to keep all the video decoders 216 continuously busy and speed up the video decoding of the segments. In some implementations, the processing circuitry 214 can assign different bitstreams (or compressed data segments thereof) to different video decoders 216. In some implementations, the GPU 210 can receive video bitstreams for multiple sessions (e.g., bitstreams captured by different egos 140 or captured at different time intervals) at the same time. The processing circuitry 214 can assign different video decoders 216 to decode video data of different sessions.

The method 300 can include the GPU 210 using the one or more image frames to train the ML model (STEP 310). Once the selected image frames are decoded, the processing circuitry 214 can extract one or more features from each selected image frame and feed the extracted features to a training module configured to train the ML model. In response, the training module can modify or update one or more parameters of the ML model.

While method 300 is described above as being performed or executed by GPU 210, in general, the method 300 can be performed or executed by any computing system that includes a memory and one or more processors. Also, another type of processors can be used instead of GPU 210.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
receiving, by a processor, a bitstream of a video sequence and one or more indications indicative of one or more image frames of the video sequence for training a machine learning model;
determining, by the processor, by parsing the bitstream, timestamps, positions within the bitstream and types of image frames of the video sequence;
determining, by the processor, using the one or more indications and the timestamps, positions within the bitstream and types of the image frames of the video sequence, one or more segments of the bitstream for decoding to extract the one or more image frames, for an image frame of the one or more image frames, a corresponding segment represents a corresponding referencing chain of image frames of the video sequence;
decoding, by the processor, the one or more segments of the bitstream; and
using, by the processor, the one or more image frames to train the machine learning model.

2. The method of claim 1, further comprising:
allocating, by the processor, a memory region within a memory of the processor;
storing, by the processor, the bitstream in the allocated memory region; and
storing, by the processor, the one or more image frames, after decoding the one or more segments, in the allocated memory region.

3. The method of claim 1, wherein for each image frame of the one or more image frames, the corresponding referencing chain of image frames starts at an intra-frame (I-frame) of the video sequence and ends at the image frame of the one or more image frames.

4. The method of claim 1, wherein determining the timestamps, positions in the bitstream, and types of the image frames of the video sequence includes generating one or more data structures, the one or more data structures indicative of: for each image frame of the video sequence, a corresponding timestamp and a corresponding offset representing a corresponding position of compressed data of the image frame in the bitstream; and image frames of a specific type in the video sequence.

5. The method of claim 1, wherein the processor is a graphical processing unit.

6. The method of claim 1, wherein the one or more segments of the bitstream are decoded by a hardware decoder integrated in the processor.

7. The method of claim 1, wherein the one or more indications include one or more time values and determining the one or more segments of the bitstream includes, for each time value of the one or more time values:
determining a first timestamp that is closest to the time value among the timestamps of the image frames of the video sequence, the first timestamp corresponding to a first image frame in the video sequence;
determining a second timestamp of an I-frame of the video sequence, the second timestamp determined as a closest I-frame timestamp to the first timestamp that is smaller than or equal to the first timestamp;
determining, using the second timestamp, a starting position of the I-frame in the bitstream among the positions of the image frames;
determining, using the first timestamp, an ending position of the first image frame in the bitstream among the positions of the image frames; and
determining a segment of the bitstream to extend between the starting position of the I-frame and the ending position of the first image frame.

8. The method of claim 1, wherein the bitstream is a first bitstream of a first compressed video sequence captured by a first camera and the method further comprising:
receiving, by the processor, a second bitstream of a second video sequence captured by a second camera;
determining, by the processor, by parsing the second bitstream, timestamps, positions within the second bitstream and types of image frames of the second video sequence;
determining, by the processor, using the one or more indications and the timestamps, positions within the second bitstream and types of the image frames of the second video sequence, one or more segments of the second bitstream for decoding to extract one or more second image frames of the second video sequence, for an image frame of the one or more second image frames, a corresponding segment of the second bitstream represents a corresponding referencing chain of image frames of the second video sequence;
decoding, by the processor, the one or more segments of the second bitstream; and
using, by the processor, the one or more second image frames to train the ML model.

9. The method of claim 8, wherein the first camera and the second camera are not synchronized with each other.

10. The method of claim 9, wherein at least two segments of the one or more segments of the first bitstream and the one or more segments of the second bitstream are decoded in parallel by at least two hardware decoders integrated in the processor.

11. A computing device comprising:
a memory; and
a processing circuitry configured to:
receive a bitstream of a video sequence and one or more indications indicative of one or more image frames of the video sequence for training a machine learning model;
determine, by parsing the bitstream, timestamps, positions within the bitstream and types of image frames of the video sequence;
determine, using the one or more indications and the timestamps, positions within the bitstream and types of the image frames of the video sequence, one or more segments of the bitstream for decoding to extract the one or more image frames, for an image frame of the one or more image frames, a corresponding segment represents a corresponding referencing chain of image frames of the video sequence;
decode the one or more segments of the bitstream; and
use the one or more image frames to train the machine learning model.

12. The computing device of claim 11, wherein the processing circuitry is further configured to:
allocate a memory region within the memory;
store the bitstream in the allocated memory region; and
store the one or more image frames, after decoding the one or more segments, in the allocated memory region.

13. The computing device of claim 11, wherein for each image frame of the one or more image frames, the corresponding referencing chain of image frames starts at an intra-frame (I-frame) of the video sequence and ends at the image frame of the one or more image frames.

14. The computing device of claim 11, wherein in determining the timestamps, positions in the bitstream and types of the image frames of the video sequence, the processing circuitry is configured to generate one or more data structures, the one or more data structures indicative of:
for each image frame of the video sequence, a corresponding timestamp and a corresponding offset indicative of a corresponding position of compressed data of the image frame in the bitstream; and
image frames of a specific type in the video sequence.

15. The computing device of claim 11, wherein the computing device is a graphical processing unit (GPU).

16. The computing device of claim 15, wherein the one or more segments of the bitstream are decoded by a hardware decoder integrated in the GPU.

17. The computing device of claim 11, wherein the one or more indications include one or more time values and in determining the one or more segments of the bitstream, the processing circuitry is configured to, for each time value of the one or more time values:
determine a first timestamp that is closest to the time value among the timestamps of the image frames of the video sequence, the first timestamp corresponding to a first image frame in the video sequence;
determine a second timestamp of an I-frame of the video sequence, the second timestamp determined as a closest I-frame timestamp to the first timestamp that is smaller than or equal to the first timestamp;
determine, using the second timestamp, a starting position of the I-frame in the bitstream among the positions of the image frames;
determine, using the first timestamp, an ending position of the first image frame in the bitstream among the positions of the image frames; and
determine a segment of the bitstream to extend between the starting position of the I-frame and the ending position of the first image frame.

18. The computing device of claim 11, wherein the bitstream is a first bitstream of a first compressed video sequence captured by a first camera and the processing circuitry is further configured to:
receive a second bitstream of a second video sequence captured by a second camera;
determine parsing the second bitstream, timestamps, positions within the second bitstream and types of image frames of the second video sequence;
determine using the one or more indications and the timestamps, positions within the second bitstream and types of the image frames of the second video sequence, one or more segments of the second bitstream for decoding to extract one or more second image frames of the second video sequence, for an image frame of the one or more second image frames, a corresponding segment of the second bitstream represents a corresponding referencing chain of image frames of the second video sequence;
decode the one or more segments of the second bitstream; and
use the one or more second image frames to train the machine learning model.

19. The computing device of claim 18, wherein the first camera and the second camera are not synchronized with each other.

20. The computing device of claim 19, wherein at least two segments of the one or more segments of the first bitstream and the one or more segments of the second bitstream are decoded in parallel by at least two hardware decoders integrated in the computing device.

21. A non-transitory computer-readable medium storing computer code instructions thereon, the computer code instructions when executed by a processor cause the processor to:
receive a bitstream of a video sequence and one or more indications indicative of one or more image frames of the video sequence for training a machine learning model;
determine, by parsing the bitstream, timestamps, positions within the bitstream and types of image frames of the video sequence;
determine, using the one or more indications and the timestamps, positions within the bitstream and types of the image frames of the video sequence, one or more segments of the bitstream for decoding to extract the one or more image frames, for an image frame of the one or more image frames, a corresponding segment represents a corresponding referencing chain of image frames of the video sequence;
decode the one or more segments of the bitstream; and
use the one or more image frames to train the machine learning model.
